(19) United States
(12) Patent Application Publication
(10) Pub. No.: US 2025/0117672 A1
(43) Pub. Date: Apr. 10, 2025

(54) CONSTRAINT-BASED PROMPTING FOR LANGUAGE MODELS TO REASON ON COMMONSENSE KNOWLEDGE BASES

(71) Applicant: The Hong Kong University of Science and Technology, Hong Kong (CN)

(72) Inventors: Van Quyet DO, Hong Kong (CN); Tianqing FANG, Hong Kong (CN); Zhaowei WANG, Hong Kong (CN); Yangqiu SONG, Hong Kong (CN)

(21) Appl. No.: 18/893,972

(22) Filed: Sep. 24, 2024

Related U.S. Application Data
(60) Provisional application No. 63/588,298, filed on Oct. 6, 2023.

(51) Int. Cl. G06N 5/04

(52) U.S. Cl. CPC G06N 5/04

(57) ABSTRACT

Provided herein is a method of improved commonsense knowledge bases reasoning through constraint-based prompting. A novel dual-module constraint-based prompt engineering system named ConstraintChecker is involved, which employs a first rule-based module to produce a list of constraints and a second zero-shot learning module to check whether the knowledge instance satisfies all constraints. The acquired constraint-checking result is then aggregated with the output of the main prompting backbone to produce the final output. This present method is more effective in commonsense knowledge bases reasoning then that by employing the prompting backbone alone, and also significantly reduces computational costs.

### CROSS-REFERENCE TO RELEVANT APPLICATIONS

The present application claims priority from a U.S. provisional patent application Ser. No. 63/588,298 filed Oct. 6, 2023, and the disclosure of which are incorporated by reference in their entirety.

### TECHNICAL FIELD

The present invention relates to large language models. More specifically, the present invention presents a method of improving existing prompting methods in terms of reasoning over commonsense knowledge bases (CSKB).

### BACKGROUND

Commonsense Knowledge Bases (CSKB) Reasoning, as one of many commonsense reasoning tasks, has been well explored in Natural Language Processing for the past few years. As human-annotated are usually incomplete and of a small coverage, reasoning over CSKBs, i.e., CSKB reasoning, is a way for expansion. CSKB reasoning is defined as determining whether a new knowledge triple (head event, relation, tail event) is commonsense (in other expressions, being positive, plausible, or having label 1) based on the rationales and knowledge in original CSKBs as well as external, expanding CSKBs via such a reasoning process can lead to better and broader commonsense knowledge as valuable resources to augment AI models in other tasks.

Recently, inspired by the emergence of Large Language Models (LLM), a type of artificial intelligence (AI) designed to understand and generate human-level natural language, built using machine learning techniques, particularly deep learning, and are trained on vast amounts of text data that can perform decently in many commonsense reasoning tasks, attempts were made for a CSKB reasoning benchmark named CSKB Population (CKBP). However, the result shows that LLMs still fall short in the benchmark, even with a large number of in-context examples. One of the problems is that LLMs find it hard to acquire the explicit relational constraints in CSKBs, hence making wrong predictions.

In the example in FIG. 1, the xReact relation in CSKBs requires the tail event of the knowledge triple to express a mental state, such as “PersonX is confident”, instead of an action, such as “PersonX wins”. Meanwhile, LLMs fail to recognize the constraint from in-context exemplars, thus making the judgment mainly based on the semantics of the head and tail events. This leads to an incorrect prediction that the triple (PersonX prepares for the competition, xReact, PersonX wins) is plausible. In light of this, many advanced prompting techniques, such as Chain-of-Thought (CoT), Least-to-Most, Active-CoT, etc., can be possible alternatives for improvements. Nonetheless, they are task-agnostic and still suffer from the inherent shortcoming of LLMs in inducing the rules in CSKBs.

Such a shortcoming of LLMs comes from the lack of a symbolic reasoning ability. While currently deep learning best deals with perception and conventional language understanding tasks, deep learning struggles to deal with more complex, symbolic, and high-level concepts reasoning tasks. Following this statement, since the explicit rules to be handled in CSKB reasoning belong to symbolic reasoning, vanilla LLMs inherently cannot reasonably handle these rules. While some of the aforementioned prompting techniques, such as CoT and Least-to-Most, aim to boost the reasoning capabilities of LLMs by making the reasoning process more explicit and structured, the improved capabilities are most effective for the tasks that LLMs were evaluated on, e.g., arithmetic reasoning for school-math datasets and symbolic recursive reasoning for Last Letter Concatenation. Thus, they may not generalize well to other reasoning tasks and become less effective in handling explicit rules on CSKB reasoning even with the support of exemplar.

Therefore, there is a need to develop a novel method to overcome the lack of symbolic reasoning ability of LLMs on CSKB reasoning. The present invention addresses this need.

### SUMMARY OF THE INVENTION

In one aspect, the present invention provides a method of commonsense knowledge bases reasoning through constraint-based prompting.

The method of commonsense knowledge bases reasoning through constraint-based prompting comprises inputting a query containing a knowledge triple comprising head event, relation and tail event in text format into a processor comprising a backbone large language model, subjecting the query to a main-task prompt engineering system and a dual-module constraint-based prompt engineering system simultaneously, obtaining a first prompt from the main-task prompt engineering system, and subject the first prompt to the backbone large language model to obtain a first prediction, obtaining a second prompt from the dual-module constraint-based prompt engineering system, and subject the second prompt to the backbone large language model to obtain a second prediction, and aggregating the first prediction and the second prediction to obtain the final prediction.

In one embodiment, the dual-module constraint-based prompt engineering system comprises a first module and a second module, wherein the first module generates relational constraints corresponding to the query, and the second module receives the relational constraints and generates the second prompt comprising questions on whether each of the relational constraints is satisfied.

In a further embodiment, relational constraints generated by the first module comprises typing constraint, wherein the tail event of the query is constrained to express the type of content that the relation expects; and temporal constraint, wherein the temporal order of the head event and the tail event of the query is constrained to follow the order derived from the definition or human-readable template of the relation.

In another embodiment, the first prediction and the second prediction are aggregated using logical conjunction, also known as the AND operator.

In yet another embodiment, by adopting the aforementioned method, the F1 score is increased by an average margin of at least 0.75% in comparison with large language models without the dual-module constraint-based prompt engineering system.

In another aspect of the present invention, a system for utilizing method of commonsense knowledge bases reasoning through constraint-based prompting is also provided herewith, comprising a knowledge triple-query-processing module; a processor comprising (i) main-task prompt engineering system for generating a first prediction; (ii) dual-module constraint-based prompt engineering system for generating a second prediction; and (iii) aggregating module for aggregating the first prediction and the second prediction to obtain the final prediction.

The dual-module constraint-based prompt engineering system above comprises a first module generating relational constraints corresponding to the query; and a second module receiving the relational constraints and generating the second prompt comprising questions on whether each of the relational constraints is satisfied on a zero-shot basis.

In an embodiment of the second aspect, relational constraints generated by the first module comprises typing constraint, wherein the tail event of the query is constrained to express the type of content that the relation expects; and temporal constraint, wherein the temporal order of the head event and the tail event of the query is constrained to follow the order derived from the definition or human-readable template of the relation.

In another embodiment, the first prediction and the second prediction are aggregated using logical conjunction.

In other embodiment, the F1 score when adopting the above system is increased by an average margin of at least 0.75% in comparison with large language models without the dual-module constraint-based prompt engineering system.

### BRIEF DESCRIPTION OF DRAWINGS

The appended drawings, where like reference numerals refer to identical or functionally similar elements, contain FIG.s of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 provides examples of CSKB reasoning. Solid arrows represent existing triples (i.e., instances) in CSKBs, while the dashed arrows with question marks represent new knowledge triples which will be determined if they are commonsense. LLMs often fail to acquire the explicit relational constraints in CSKBs, hence making wrong predictions for many new knowledge triples.

FIG. 2 illustrates the dual-module constraint-based prompt engineering system, named ConstraintChecker. For each instance, Module 1 queries a preset rule to get all relational constraints corresponding to the instance's relation. Module 2 accordingly constructs questions to ask whether each constraint is satisfied, and passes these questions to the backbone LLM to get predictions. Together with the prediction from the main-task component, logical conjunction (i.e. \hat{ } or AND operator) is used to aggregate the final prediction.

FIG. 3 illustrates the effectiveness of ConstraintChecker (Constraint) comparing to other types of prompt engineering, including the uses of exemplar (Use Ex.), exemplar optimization (Select), and chain-of-thought (CoT).

FIG. 4 shows a table stating the relations on range of effect of each constraint.

FIG. 5 tabulates the Random, Human and previous best Supervised Learning baselines' performance as a lower bound, upper bound and a competitive baseline to compare with LLM prompting methods. Acc., Pre., Rec. respectively stands for accuracy, precision and recall. The random baseline follows the Bernoulli distribution with probability p=0.5. Results of baselines with suffix (full set) are results on the whole test set of CKBP v2. For the last two rows, available human annotation of CKBP v2 is used and rebuild the best baseline to compute these statistics. Results suggest that the down-scaled test set is representative of the whole test set.

FIG. 6 shows the main experimental results on the test data. Results are reported in four metrics, including accuracy (Acc.), precision (Pre.), recall (Rec.) and F1 score, where F1 is the main metric. The best performance (F1) is shown in bold. As observed, ConstraintChecker provides consistent improvements over prompting methods.

FIG. 7 shows the ablation study on each constraint and prompt choice. P.D. in the setting names abbreviates “prompt design”. Results are F1 scores with respect to triples of each relation. The notation “-” indicates no change in comparing to the result of the zero-shot baseline, because those constraints-relation pairs are not considered in the preset rule (either pre- or post-pilot-study) with respect to the setting.

FIG. 8 shows the results in the pilot study, presented in a similar organization as FIG. 7.

FIG. 9 tabulates the average precision, recall and F1 score over all baselines of each seed prompt design. No significant dependence of baseline performance on seed prompt designs is present.

FIG. 10 shows the per-instance estimated costs for baselines and additional costs for each type of prompt engineering, including “using exemplars”, “using CoT” and ConstraintChecker. Numbers in the “Run” column indicate the number of times baselines are run. “Words” indicates the average of words in prompt and generated which are both charged by OpenAI. “Total” shows the total number of words processed which are proportional to the actual costs. For types of prompt engineering other than ConstraintChecker, the average gap between two groups of baselines is taken with respect to the type. It is generously assumed here that all constraints of ConstraintChecker are run for every instance, instead of only instances of concerned relations as following the preset rule.

FIG. 11 tabulates the taxonomy of CSKB relations cited from previous works, namely Sap et al., “ATOMIC: An Atlas of Machine Commonsense for If-Then Reasoning” (2019), The Thirty-Third AAAI Conference on Artifcial Intelligence, AAAI, 2019, The Thirty First Innovative Applications of Artificial Intelligence Conference, IAAI 2019, The Ninth AAAI Symposium on Educational Advances in Artificial Intelligence, EAAI 2019, Vol. 33 No. 1, pp. 3027-3035 and Hwang et al., “(Comet-)Atomic 2020: On Symbolic and Neural Commonsense Knowledge Graphs” (2021), Thirty-Fifth AAAI Conference on Artificial Intelligence, AAAI 2021, Thirty-Third Conference on Innovative Applications of Artificial Intelligence, IAAI 2021, The Eleventh Symposium on Educational Advances in Artificial Intelligence, EAAI 2021, Vol. 35 No. 7, pp. 6384-6392. In the context of the present invention, only 15 relations included in CKBP v2 are selected.

FIG. 12 tabulates the readable templates from Hwang et al. (2021) (denoted as H-template), concerning 15 relations which comprise CKBO v.2 When these templates are used in the main-task component, the head and tail events will be respectively prepended and appended to the templates.

FIG. 13 tabulates the self-curated readable templates (denoted as S-template) for 15 relations in CKBP v2. <h> and <t> denote the head and tail event respectively.

FIG. 14 shows the constraint prompt designs for typing, temporal and ambiguity constraints. <h> and <t> denote the head and tail event respectively.

FIGS. 15, 16 and 17 show the prompt designs of baselines. H-template and S-template denote two sets of readable templates, from Hwang et al. (2021) and self-curated respectively. For baselines which select exemplars randomly or based on the test instance, the exemplars will change according to each test instance, rather than remaining the same as what are shown here.

FIG. 18 depicts a block diagram for a system 200 for utilizing method of commonsense knowledge bases reasoning through constraint-based prompting according to some embodiments of the present invention. The system 200 includes a knowledge triple-query-processing module 210, a main-task prompt engineering system 220, a dual-module constraint-based prompt engineering system 230, and a aggregating module 240.

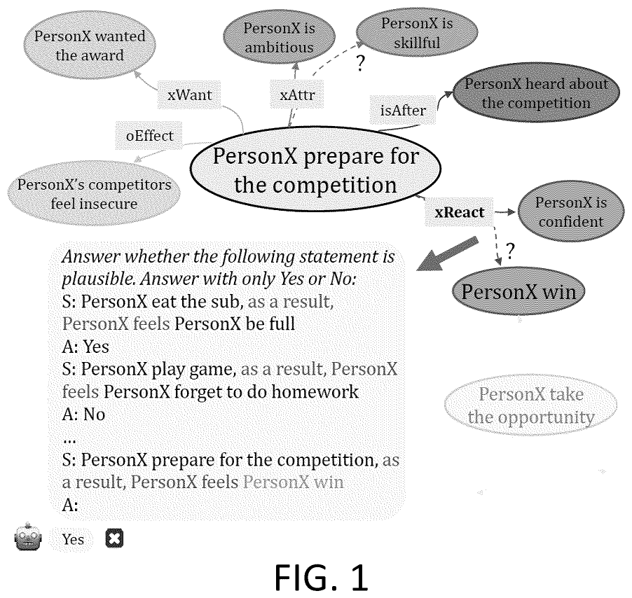

### DETAILED DESCRIPTION

As used below in the specification, “precision” is defined as the ratio of correctly predicted positive observations to the total predicted positives, which indicates how many of the predicted positive results are actually positive. Precision is calculated as follows:

$$Precision = \frac{True Positives ( TP )}{True Positives ( TP ) + False Positives ( FP )}$$

As used below in the specification, “recall” is defined as the ratio of correctly predicted positive observations to all observations in the actual class. It measures how many of the actual positive cases the model correctly identifies. Recall is calculated as follows:

$$Recall = \frac{True Positives ( TP )}{True Positives ( TP ) + False Negatives ( FN )}$$

As used below in the specification, “F1 score” refers to a common metric to evaluate the performance of LLMs, defined as the harmonic mean of precision and recall, calculated as follows:

$$F 1 Score = 2 \times \frac{Precision \times Recall}{Precision + Recall}$$

Commonsense knowledge bases reasoning (CSKB) refers to the ability of artificial intelligence systems to understand and apply general world knowledge considered obvious by most humans, which involve making inferences and decisions based on everyday experiences, social norms or facts about the world. Under CSKB reasoning, AI is enabled to perform tasks which require context, causality and relationships between objects and events in the real world.

However, vanilla LLMs, while typically excelling at pattern recognition, lacks capability in inferring causality between two objects or events, and therefore inherently incapable of handling CSKB reasoning.

To this end, a dual-module constraint-based prompt engineering system named ConstraintChecker is provided in the present invention, which functions as a plugin component for LLMs to handle the problem of explicit constraints in CSKB reasoning. ConstraintChecker supports LLM reasoning as an independent component in addition to the main-task component that determines whether a knowledge triple is commonsense or not.

Given a knowledge triple (head event, relation, tail event), a rule-based/symbolic module is first employed to produce a list of constraints based on the relation. The list is then passed to a zero-shot learning module, where we construct constraint-checking questions and use the same LLM as in the main-task component in a zero-shot manner to check whether the instance satisfies all constraints. The acquired constraint-checking result is then aggregated with the prediction from the main-task component by logical conjunction to produce the final prediction.

As shown below, not only is the ConstraintChecker able to improve effectiveness of LLMs in CSKB reasoning, but it also reduces the computational cost of the LLM, thereby also increasing the operational efficiency of the processor.

### EXAMPLES

### Example 1—ConstraintChecker

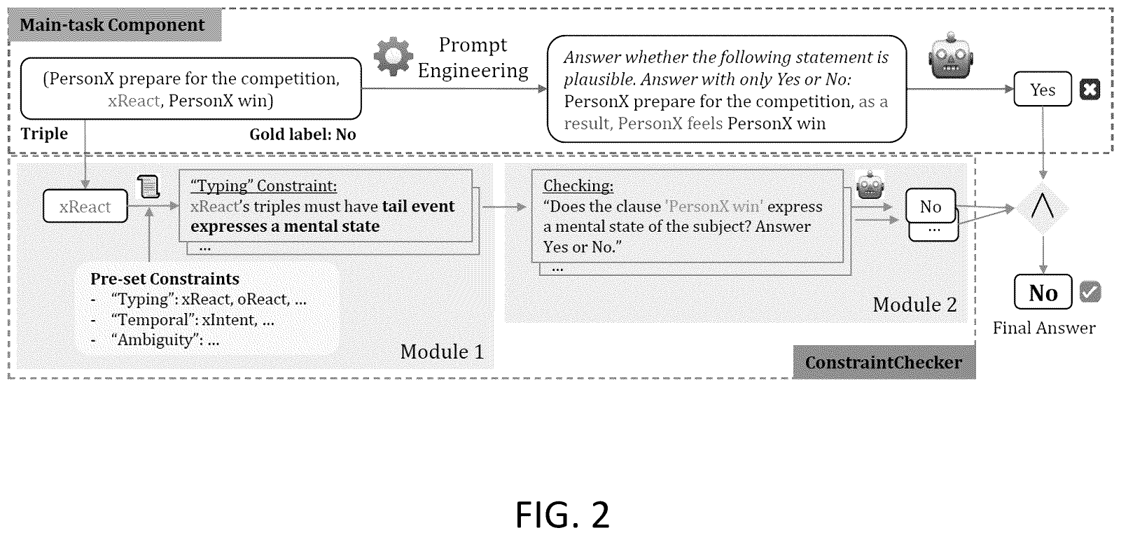

An overview of the proposed dual-module constraint-based prompt engineering system, ConstraintChecker, is shown in FIG. 2. The CSKB reasoning focused on is inherently a binary classification task and the expected outputs are either plausible or implausible. ConstraintChecker consists of two modules, entitled Module 1 and Module 2. For each instance, Module 1 queries a preset rule to get all relational constraints corresponding to the instance's relation. Module 2 then constructs questions accordingly to ask whether each constraint is satisfied, and passes these questions to the backbone LLM to get predictions. Together with the prediction from the main-task component, the logical conjunction (AND operator) is used to aggregate the final prediction. ConstraintChecker only has an effect on instances that are predicted as commonsense (or “Yes”, corresponding to plausible) by the main-task component, and can only change the prediction from “Yes” to “No”, in view of the nature of logical conjunction. Thus, it targets and corrects False-Positive predictions.

It will be elaborated below how the pool of constraints and the preset rule are selected to map relations to constraints in Module 1, as we as the constraint-checking prompt design in Module 2 concerning the benchmark CKBP v2.

### 1.1 Constraints Selection

The definitions of CSKB relations in previous works are followed, including the taxonomy of if-then reasoning types and human-readable templates for crowdsourced evaluation, to derive the set of considered constraints and the rule to apply constraints. For example, the readable template “as a result, PersonX feels” of the xReact relation suggests the “temporal” constraint, in which the head event must happen before the tail event, and the taxonomy of xReact implies the “typing” constraint, in which the tail event must express a mental state. Note that the template “as a result, PersonX feels” of xReact may not strictly impose the typing constraint on the tail event, due to a subtle problem in natural language. For example, for humans, two text sequences “as a result, PersonX feels PersonX will win” and “as a result, PersonX feels PersonX is confident” all make sense, although “PersonX will win” completely does not express a mental state of PersonX.

In addition, as suggested by prior works that many commonsense datasets have significant portions of ambiguous instances the “ambiguity” constraint is also considered. Among possible constraints, the most likely needed constraints are shortlisted, namely typing, temporal, and ambiguity constraints. The formal definition of each constraint is as follows:
Typing: The tail event has to express the type of content (one among three types: event, mental state, persona) that the relation expects
Temporal: The (estimated) temporal order of the head event and the tail event must follow the order derived from the definition/human-readable template of the relation. For example, for the HinderedBy relation, the head event must happen after the tail event.
Ambiguity: The meaning of the head and tail events must not be ambiguous. For example, “PersonX orders a salad” is not ambiguous, while “PersonX would like” is ambiguous.

### 1.2 Preset Rules

Each relation will be mapped into a set of constraints based on the aforementioned taxonomy and templates, as well as human-readable templates used by the main-task component in terms of how well the template of the relation semantically reflects the constraints of that relation. For example, the template of xReact “as a result, PersonX feels” does contain the phrase “as a result” representing the temporal constraint which is needed to check. To refine the rule, we conduct a pilot study on ChatGPT to estimate the effectiveness of designated constraints on each relation. According to the results of the pilot study, we remove ineffective constraint-relation pairs to refine the rule. We further conduct an ablation study on the main experiments with respect to ChatGPT to show the ineffectiveness of removed relation-constraint pairs.

### 1.3 Constraint-Checking Prompt Design

As a zero-shot LLM is used to check constraints, questions are constructed for derived constraints in a direct question-answering manner. For example, for the typing constraint, which requires the tail event of the triple to express a mental state, a prompt is designed as “Does the clause <tail event> express a mental state of the subject? Answer Yes or No”. Notably, due to the robustness of LLMs and the fact that constraint satisfaction is a relatively simple task that does not require complex reasoning, exemplars for constraint-checking questions are not needed. For each constraint, two templates are designed to seek the best one. Overall, the following prompt designs are chosen for typing and temporal constraints respectively:
Typing: “Which aspect (among three options 1. event/activity, 2. persona, 3. mental state) of the subject does the clause <tail event> express. Answer the choice only.”
Temporal: “Which one of the following two statements is more plausible: 0. <tail event> before <head event>, 1. <tail event> after <head event>. Answer 0 or 1 only.”

Since the chosen prompts do not standardly question whether the constraint is satisfied, a snippet of code is used to convert the acquired prediction into the Yes/No answer for the standard constraint-checking question.

### Example 2—Experiments

### 2.1 Benchmark

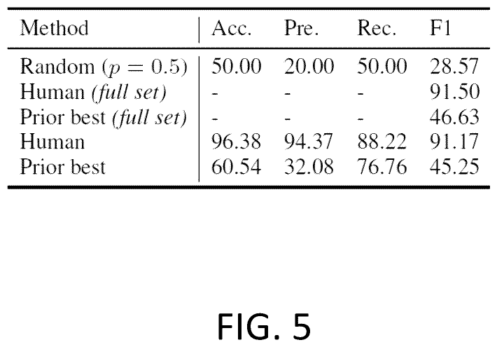

CKBP v2, which originally consists of approximately 1 k development instances and 4 k test instances, as the CSKB reasoning benchmark for evaluation. To reduce the computational cost while keeping the same data distribution, stratified sampling is used to downscale the test split of the benchmark by a factor of 4, hence forming a test set of 979 instances. The down-sampled test set includes 208 instances with label 1 (which means they are commonsense or “positive”), thus, the ratio of the number of commonsense/not commonsense instances remains approximately ¼. From this point, by default, the terms “test set” and “test data” refer to the set of these 979 instances. In fact, results of human-performance baseline and supervised-learning baseline in FIG. 5 suggest that the down-scaled test set is representative of the whole test set.

### 2.2 Setups

Baselines: The following methods serve as the main-task component's prompting methods in the experiments.
Zero-shot: standard zero-shot prompting, which directly asks the task question and “force” LLMs to only return the final answer without any explanation
Few-shot: standard prompting which uses exemplars to facilitate in-context learning. Here, three variants which are different in the way they select exemplars are considered. In detail, the below are used:
   Random exemplar selection
   KATE, which chooses exemplars that are the most semantically similar to the test instance using sentence embedding models
   KATE-s, a special version of Few-shot KATE for CSKB reasoning, in which the selected exemplars must have the same relation as the test instance
Zero-shot-CoT: the zero-shot prompting technique which uses the phrase “Let's think step by step” to stimulate LLMs to generate rationales before providing the final answer.
Few-shot-CoT: chain-of-thought methods which use exemplars. Similar to Few-shot, we introduce three variants of Few-shot-CoT. The simplest Few-shot-CoT randomly selects exemplars, while the other two, Active-CoT and Automate-CoT respectively use uncertainty-based active learning and rational chains optimization for exemplar selection.

The experiments are based on two large language models: ChatGPT (gpt-3.5-turbo) and GPT3.5 (text-davinci-003), as they are available and the most capable models at the time the experiments are conducted.

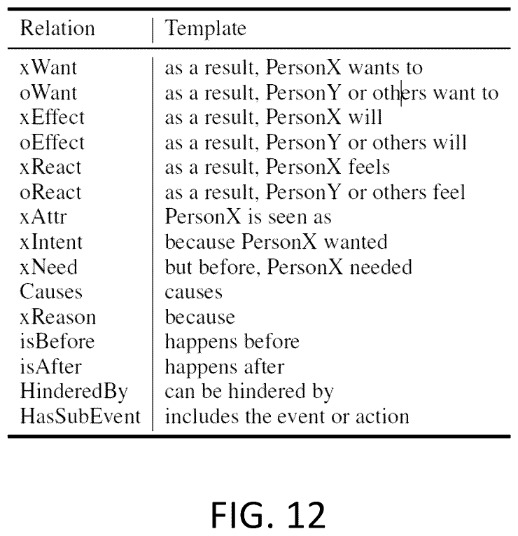

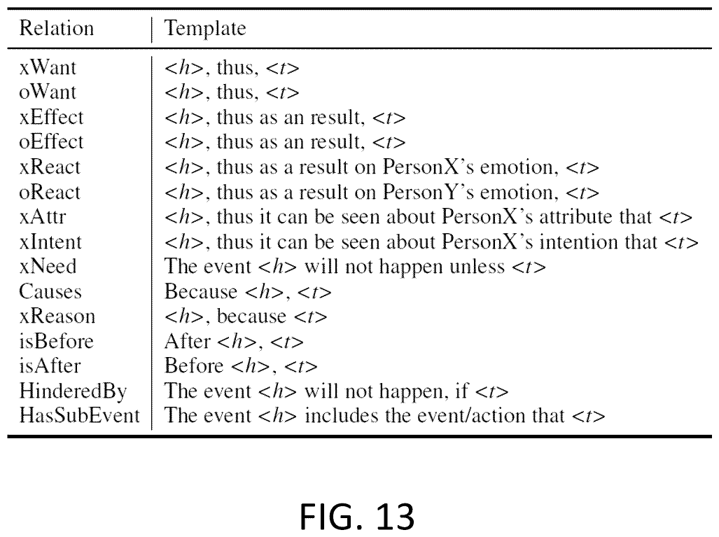

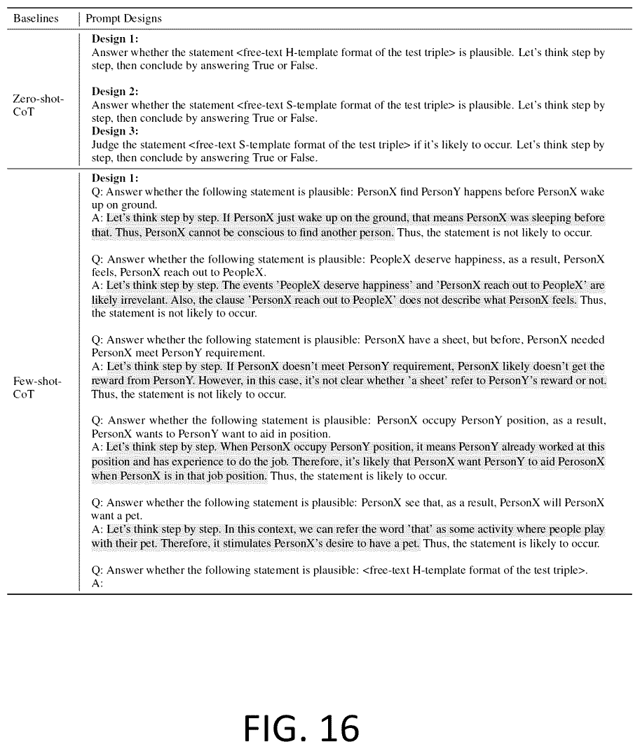

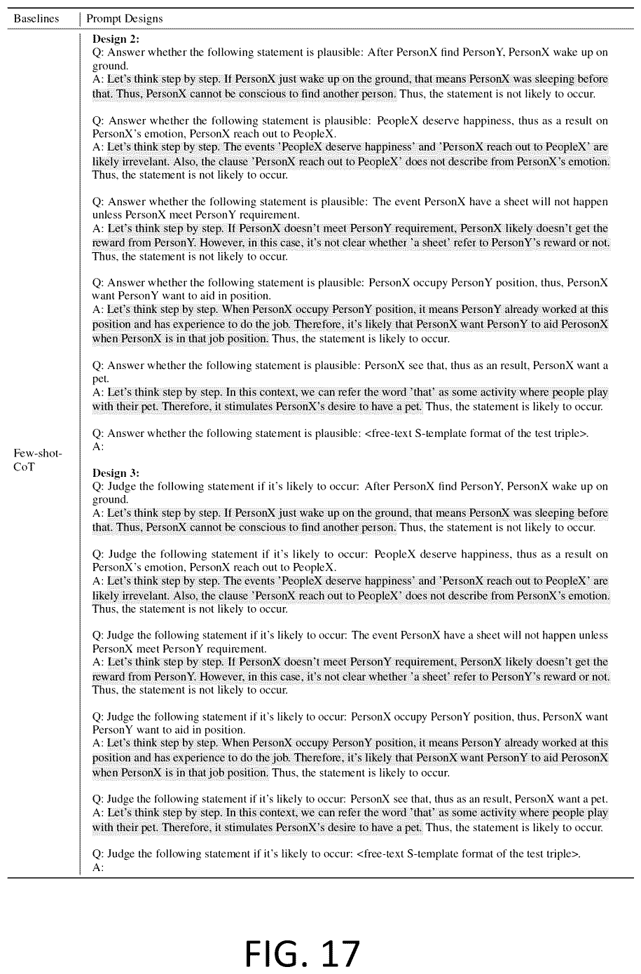

Prompt Template Design: For each triple (head event, relation, tail event), we convert the triple into a free-text format (so-called assertion) using human-readable templates. Along with the original set of templates in Hwang et al. (2021), we also design and experiment with another set of templates to study the correlation between human-readable template design and the result. Likewise, we take the direct question-answering prompt (so-called main question) design from Fang et al. (2023) and self-curate another one. The two sets of human-readable templates and two main question designs are shown in FIGS. 12-17.

Input to LLMs: An input prompt to LLMs consists of two main parts, the main question and the assertion. Three combinations of human-readable templates of relations and main question designs as seed prompt designs are selected, from which each baseline will adapt to get its three prompt designs (if necessary). The result of each baseline will be averaged from results of three different prompt designs. Details about the prompt designs are shown in FIGS. 12-17.

Exemplars: By default, exemplars are converted to free-text form using the same set of templates as the test instance. All exemplars are selected from the training set provided in Fang et al., “Ckbp v2: An expert-annotated evaluation set for commonsense knowledge based population” (2023), ArXiv, abs/2304.10392 regardless of labels, and the number of exemplars used in each prompt is 5.

Although recent studies show the effectiveness of self-consistency prompting, it is opted out from the present invention. Self-consistency can be viewed as a “beam search” method for the optimal reasoning path as well as the most probable final answer at the end of the reasoning path, which overcomes the drawback of greedy decoding in long-sequence generation. Meanwhile, in almost all baselines experimented, the final answer is produced at the beginning of the output, thus the greedy decoding poses no significant drawback.

About LLMs, temperature is set as T=0 for all experiments, which corresponds to greedy decoding, except the exemplar construction/selection procedure of Active-CoT and Automate-CoT where the original implementations in Diao et al., “Active prompting with chain-of-though for large language models” (2023), ArXiv, abs/2302.12246; and Shum et al., “Automatic prompt augmentation and selection with chain-of-though from labeled data” (2023), Arxiv, abs/2302.12822 respectively are followed. For KATE strategy, the best sentence embedding model reported in Liu et al., “What makes good in-context examples for GPT-3?” (2022), Proceedings of Deep Learning Inside Out (DeeLIO 2022): The 3^{rd} Workshop on Knowledge Extraction and Integration for Deep Learning Architectures, pp 100-114 is used.

### 2.3 Results and Analysis

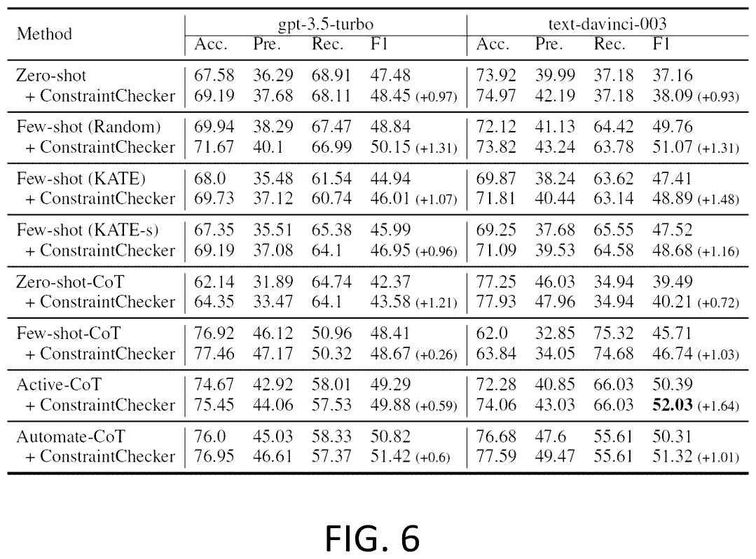

The experimental results are shown in FIG. 6. Accuracy is reported with respect to all instances, precision, recall, and (binary) F1 score with respect to the positive class of all baselines and the present method. F1 is the main metric, and in the columns corresponding to F1 score, we add numbers in scriptsize to indicate the performance gain of ConstraintChecker over prompting methods. Different from Fang et al. (2023), domain, out-of-domain, and adversarial subset are not separated in the test split, since the experiments are all zero/few-shot.

Overall, the method of the present invention consistently improves over all prompting methods and backbone LLMs, by an average margin of 0.87% and 1.11% in F1 score with respect to backbone ChatGPT and GPT3.5. Similar performance gain can be also observed in two groups of non-CoT and CoT baselines. Furthermore, with ConstraintChecker paired with Active-CoT, the SoTA result on the CKBP v2 benchmark is achieved.

Further analysis of the results points out the source of improvement of ConstraintChecker and to compare the improvement brought by the present method and by main-task prompting techniques.

The relations xReact, oReact, xAttr are taken with the Typing constraint as an example to show the effect of ConstraintChecker on GPT3.5. When ConstraintChecker is applied, the final prediction will be the logical conjunction of predictions from the zero-shot baseline and ConstraintChecker. Thus, triples that the present method has effect on are those with positive predictions from the zero-shot baseline and negative predictions from ConstraintChecker. As the present method aims to correct False Positive predictions (and not to hurt True Positive predictions), it is examined among concerned triples, how many cases ConstraintChecker:
correctly judges a triple as it violates the constraint, and because the triple's gold label has to be not commonsense (except incorrect human annotation), thus help to turn the False Positive prediction of the baseline to True Negative;
incorrectly judges a triple as it violates the constraint (in fact it does not), however, because the triple's gold label is not commonsense, the misjudgment accidentally helps to turn the False Positive prediction of the baseline to True Negative;
incorrectly judges a triple as it violates the constraint (in fact it does not), and because the triple's gold label is commonsense, the misjudgment undesirably turns the True Positive prediction of the baseline to False Negative.

It should be noted that ConstraintChecker is designated for the first category. Therefore, the more the first category happens in comparing to the second and third categories, the more reliable the improvement of ConstraintChecker is. Four external voluntary graduate NLP researchers who have at least one year of experience working on CSKBs are asked to annotate the typing constraint status (i.e “satisfied” or “not satisfied”) of those considered triples. The Fleiss' Kappa score of this annotation is 0.2381, and the final label is the majority vote among four annotators. From relevant annotations and predictions, the percentage of cases falling into each mentioned category is calculated, and find that 93% of the concerned triples fall into the first category. Similarly, when considering other relations and other baselines, the majority of the cases are observed to fall into the first category. That shows the valid source of improvement of ConstraintChecker.

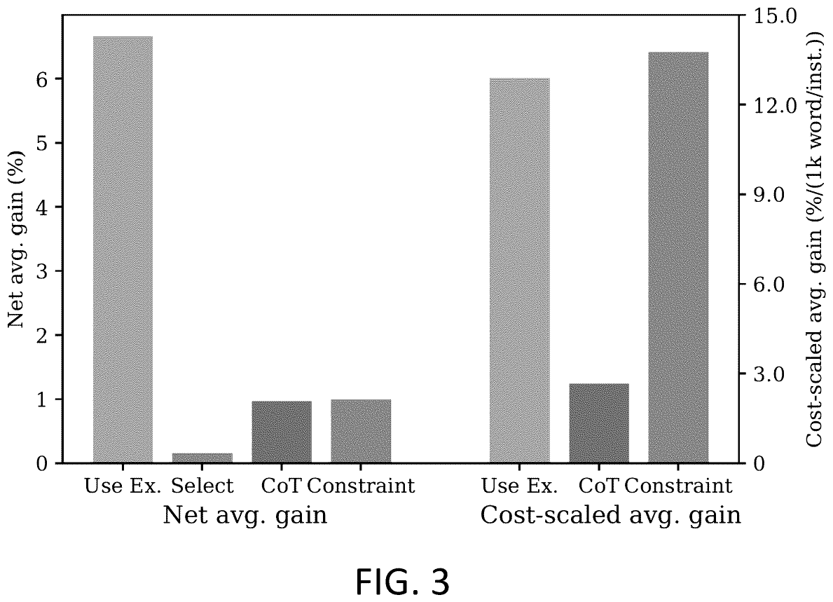

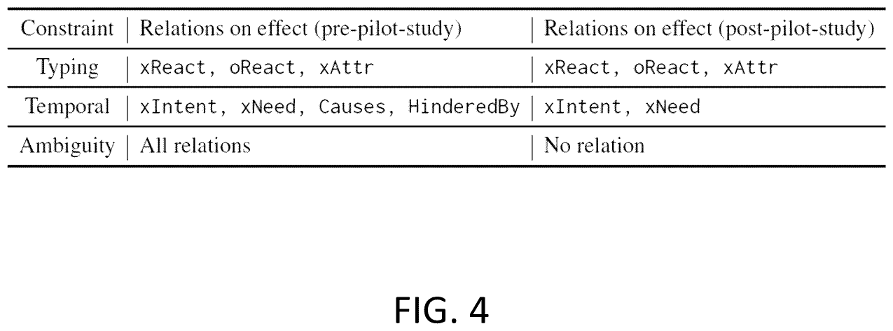

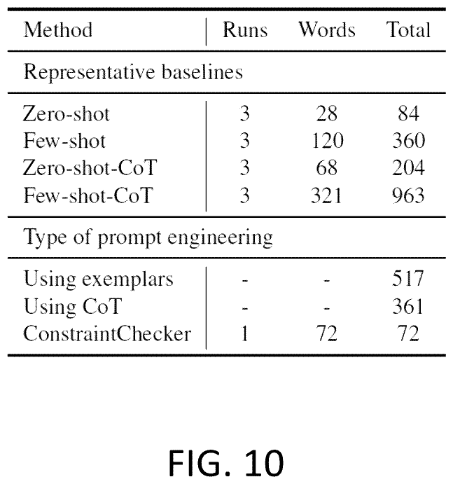

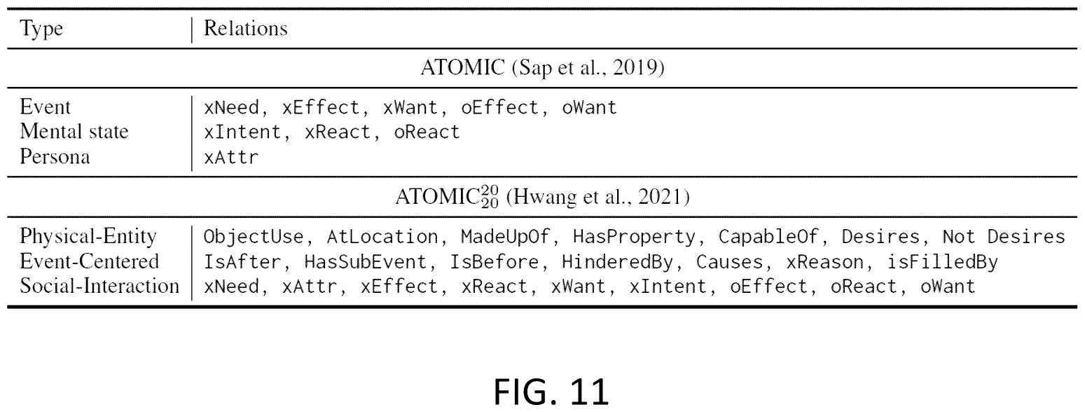

The average effectiveness of the present method is also compared with other types of prompt engineering, including 1. the use of exemplars, 2. exemplar optimization, and 3. chain-of-thought. The effectiveness (i.e. net average gain) of each prompt engineering type is estimated as the average difference of F1 score between two groups of baselines with or without the appliance of such a type. The cost-scaled average gain (i.e. the net average gain/cost ratio) is further estimated, where the cost is estimated in FIG. 10. The results are presented in FIG. 3. First, the usage of exemplars brings a remarkable improvement. In fact, exemplars help to hugely increase the recall of zero-shot baselines with GPT3.5 backbone. However, it is deemed to the strictness of GPT3.5 in judging if a knowledge triple is commonsense, as its zero-shot baselines have a much lower recall compared to other baselines (observed in FIG. 6). Meanwhile, the improvement of ConstraintChecker is consistent over all baselines as it helps to correct False-Positive predictions. It improves the precision of baselines and does not significantly hurt the recall. Also, the present method is much more efficient than the use of exemplars and CoT due to the simple prompt design, which allows ConstraintChecker to have the largest improvement over cost ratio.

### 2.4 Ablation Study

Several additional experiments on ChatGPT are further conducted to show the importance of the preset rule, constraint-checking prompt choices, and the role of ConstraintChecker as a separate module from the main-task component.

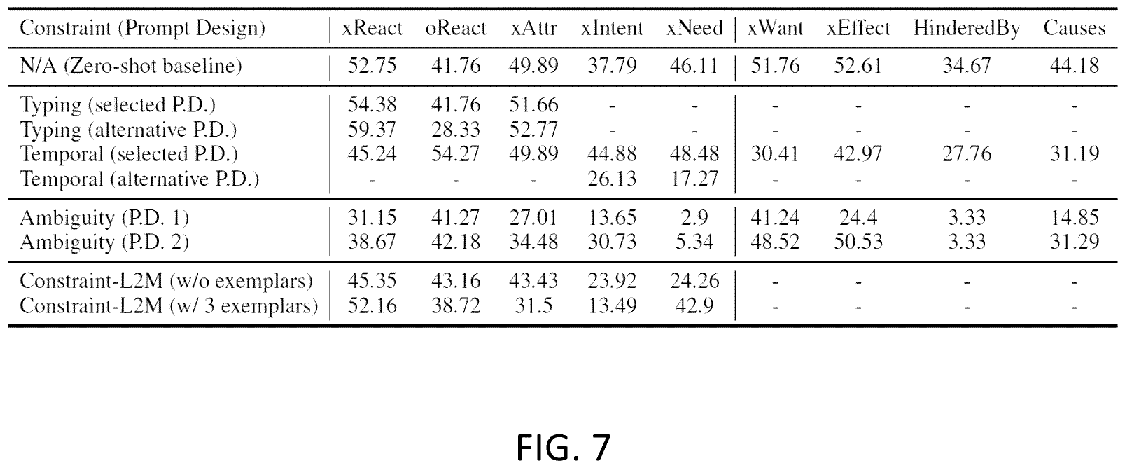

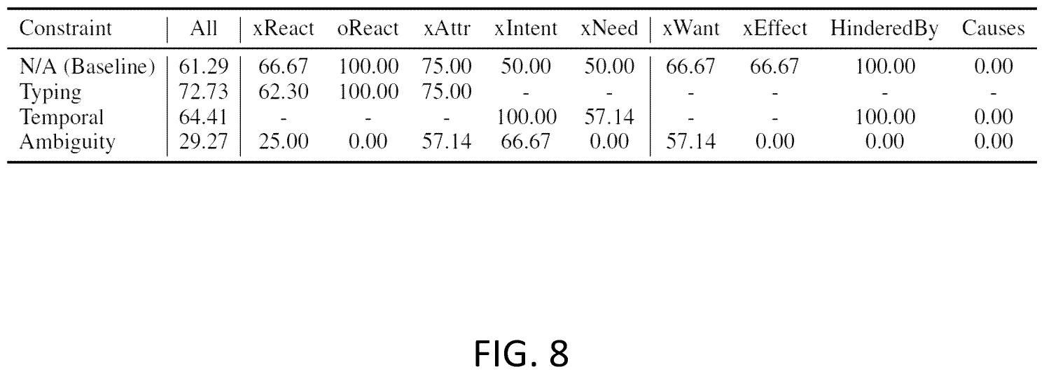

The result of the zero-shot baseline with each constraint and each prompt design applied is reported in FIG. 7. The F1 score of test triples of 5 relations are focused on, namely xReact, oReact, xAttr, xIntent, and xNeed, in which ConstraintChecker has an effect according to the final preset rule, as well as on 4 extra relations: xWant, xEffect, HinderedBy, and Causes. The F1 score of these relations are shown because xWant and xEffect account for a large portion of the test set, while HinderedBy and Cause were set to be checked with temporal constraints before the pilot study.

Effect of preset rules: In previous analysis, where and how ConstraintChecker improves the results of other main-task prompting methods are shown. However, it does not mean both typing and temporal constraints are necessary. As observed in two rows, Typing (selected prompt design, P.D. for short) and Temporal (selected P.D.), of FIG. 7, each constraint boosts the performance on each relation that they have the effect on according to the post-pilot-study preset rule. This demonstrates the importance of each selected constraint.

Similarly, the result regarding constraint-relation pairs is studied, which are never in or removed from the preset rule after the pilot study. As shown in FIG. 7, for Temporal (selected P.D.) constraint, the F1 score on HinderedBy and Causes is lower than the counterparts in the zero-shot baseline. Also, for other relations which are never in the preset rule of the temporal constraint, such as xWant and xEffect, the constraint often hurts the performance. Apart from that, the Ambiguity constraint (in both prompt designs shown in FIGS. 12-17) also hurts the performance of all unconsidered constraint-relation pairs. This is consistent with the observation in the pilot study.

Effect of the prompt design: The prompt designs of typing and temporal constraints are also ablated to study the effect of constraint question design on the performance of triples of each relation. In FIG. 7, Typing (alternative P.D.) and Temporal (alternative P.D.) indicate the result concerning the alternative prompt design for typing and temporal constraints respectively. The alternative prompt designs (shown in Appendix C.2) are formulated in a more direct way that asks if the constraint is satisfied/violated, while the selected prompt design asks more general multiple-choice questions. It can be seen that the alternative for the typing constraint gives a higher score for xReact and xAttr but a much lower score for oReact. Also, the alternative prompt for temporal constraints is significantly worse than the selected prompt design. The reason could be the advantage of having more context and references when asking general multiple-choice questions than when focusing on a specific case. This demonstrates the sensitivity of the method of the present invention to constraint prompt design.

Effect of ConstraintChecker as an independent component: ConstraintChecker is used in a plug-and-play manner, where predictions can be obtained independently from the main-task prompting. In this part, an alternative design choice that models ConstraintChecker as an end-to-end CoT-like pipeline that directly adds to the main-task prompt is studied. This serves as an additional experiment to demonstrate the effectiveness of the plug-and-play design as opposed to fusing constraints into the main-task prompts.

Taking reference from Least-to-Most (L2M) which first decomposes a complex problem into a list of easier subproblems and then sequentially solves these subproblems in different passes to LLM to reach the final answer, in this ablation, constraints are treated as easier subproblems and the main question as the hardest question which is asked ultimately. The CoT will immediately stop and conclude that a triple is not commonsense if the triple does not satisfy the constraint. The alternative method is named Constraint-L2M for simplicity. Results in FIG. 7 show that even with exemplars (3 exemplars which represent 3 cases: 1. the instance does not satisfy the constraint, 2. the instance satisfies the constraint and is predicted as not commonsense, and 3. the instance satisfies the constraint and is predicted as commonsense), Constraint-L2M hurts the performance on all considered relations, in contrast to ConstraintChecker. This shows the importance of separateness of the present invention from main-task prompting methods, as fusing the constraints into the main-task prompt can make the original problem even harder for LLMs to answer.

### Example 4—Related Works

### 4.1 Reasoning Ability

The capacity for reasoning is fundamental to human intelligence and is an attribute that is much sought after in machine learning models. This ability can be broken down into multiple facets such as commonsense reasoning, arithmetic reasoning, and logical reasoning. Historically, machine learning has leveraged symbolic systems for reasoning. Additionally, pre-training approaches have been employed to great effect.

In recent times, significant strides have been made in the realm of reasoning through large language models that employ chain-of-thought prompting techniques. Researches have exemplified this, where the models, guided by well-structured prompts, have showcased superior reasoning capabilities, outperforming predecessors on various benchmarks. However, when it comes to Commonsense Knowledge Bases (CSKB) reasoning, they often fall short in handling the explicit relational constraints in CSKBs, which accompanies the commonsense reasoning problem in CSKB reasoning. The present invention, therefore, serves as a problem-specific solution for LLMs and other prompting techniques to cope with the problem.

### 4.2 CSKB Reasoning

Commonsense knowledge bases store commonsense knowledge in the format of (head event, relation, tail event) triples. Reasoning on CSKB is formally defined as: given a knowledge triple T=(head event, relation, tail event), the task is to assign a binary label y∈{0, 1} indicating whether the triple T is commonsense or not. Reasoning on CSKBs is usually classified into two categories, CSKB Completion and CSKB Population. CSKB Completion aims at filling the missing knowledge among existing entities in the original CSKBs, while CSKB Population focuses on determining new knowledge from external domains. Besides the discriminative setting which is inherently a triple classification task, there is also a generative setting for CSKB Completion and Population to automatically generate new knowledge from language models. In fact, the main task focused on, CKBP v2, includes a CSKB completion subtask referred to as an in-domain subset, which adds to the comprehensiveness of the evaluation. Despite previous efforts in CSKB reasoning, most of them are based on knowledge base embeddings or fine-tuning pre-trained language models, and less effort has been dedicated to studying how to use LLMs for CSKB reasoning. This research gap is addressed by studying a constraint-checking plugin to enhance the performance of LLMs.

### 4.3 Constraint Modelling in Traditional Knowledge Base

Integrating rules or constraints into reasoning systems on traditional knowledge bases (KB) and knowledge graphs (KG) has long been studied. Studies have been conducted to (i) incorporate rules seamlessly into embedding models for KB completion during inference time by formulating inference as an integer linear programming (ILP) problem, (ii) investigate the effect of type-constraints on the statistical modeling with latent variable models for large knowledge graphs. More recently, other attempts have been made to improve KG embedding by modeling rules and constraints in the learning objective. The present invention, by contrast, employs an explicit use of constraints during inference time to improve the performance of large language models on CSKB reasoning.

### 4.4 Prompting Methods in LLMs

While simple prompt engineering and vanilla in-context learning have already witnessed remarkable performance in various NLP tasks, there are more sophisticated prompt paradigms to elicit better reasoning capabilities. One representative paradigm is chain-of-thought (CoT) prompting, which enriches the few-shot examples with explicit reasoning steps towards the final answers, leading to the emergence of many complex reasoning abilities such as arithmetic and commonsense reasoning. Following CoT, other techniques adopt self-consistency, least-to-most that break down each question into sub-steps, pre-trained verifiers to validate the reasoning path, diversity-based methods for CoT selection, restrict explicit and rigorous deductive reasoning of intermediate CoT reasoning processes, uncertainty-based methods for CoT selection and annotation, and automatic prompt augmentation and selection with CoT. The present invention differs from those CoT-based prompt techniques in that add-on constraints are studied to be applied to the result of any prompting technique.

### Example 5—Pilot Study

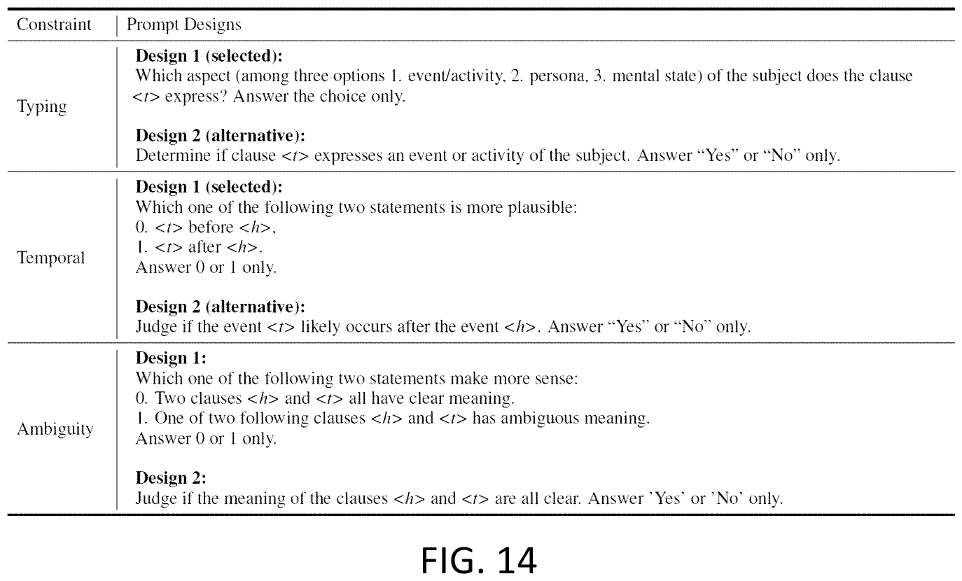

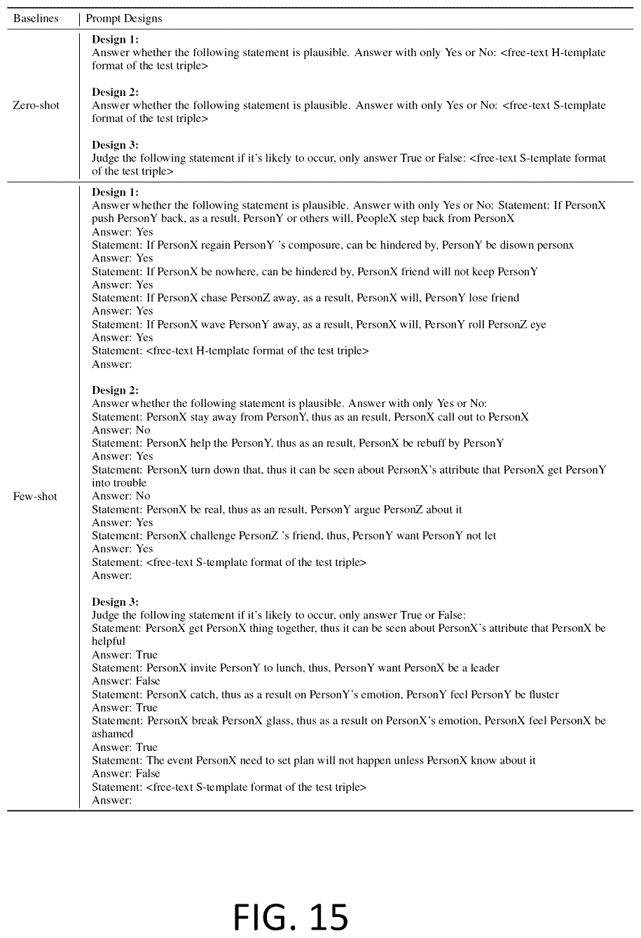

102 instances from the dev split of CKBP v2 are sampled in a relation-wise stratified manner to form a small dataset for a pilot study. The prompt design used in this pilot study consists of zero-shot template design 3 (FIG. 15), constraint template design 1 for Typing and Temporal, and template design 2 for Ambiguity (FIG. 14). The result is as follows, with a similar organization as FIG. 7. We observed no effect of the Ambiguity constraint, thus the constrain is dropped. Furthermore, as no effect of the Temporal constraint is observed on samples of relations HinderedBy and Causes, these constraint-relation pairs are removed. Nonetheless, while there is no effect of the Typing constraint on samples of relations oReact and xAttr, kept these constraint-relation pairs ARE STILL KEPT because the readable templates of the two relations do not adequately reflect their Typing constraint.

### 5.1 Analysis

As observed in FIG. 6, two groups of non-CoT and CoT baselines have the results with respect to ChatGPT and GPT-3.5 showing different patterns. While non-CoT baselines with the backbone ChatGPT do not benefit much from or even suffer from a performance decrease due to exemplars, the non-CoT baselines with GPT-3.5 and all CoT baselines hugely benefit from in-context exemplars and are 6% to 10% better than their corresponding zero-shot counterparts. Exemplar optimization becomes more important for CoT baselines, as the optimization gives a significant gain on ChatGPT and a large improvement on GPT-3.5. Also, CoT baselines generally achieve higher scores than non-CoT baselines, which is often observed in other benchmarks.

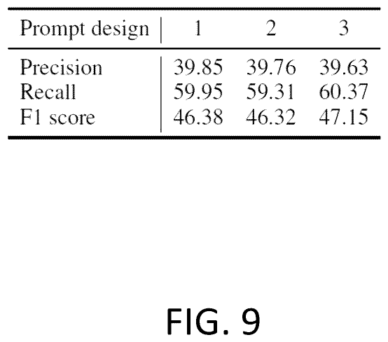

The dependence of overall baseline performance on the three seed prompt designs is further explored. The average precision, recall, and F1 score over all baselines with respect to each prompt design are reported in FIG. 9. There is a gap between the third seed prompt design and the other two seed prompt designs; however, the gap is not significantly large. Therefore, it is concluded that there is no significant dependence of baseline performance on seed prompt designs.

Also, it is also examined to what extent LLMs fail to handle the explicit constraints. A specific context is focused on, which considers the prediction of the Few-shot-CoT baseline (with ChatGPT backbone and the third prompt design) and the xReact relation. As the Few-shot-CoT baseline works on the main-task question of whether a triple is commonsense, its prediction is not equivalent to the prediction of whether the triple satisfies the constraint. Only its “Yes” prediction implies a “Yes” prediction of constraint satisfaction. Thus, the failure rate of the Few-shot-CoT baseline is estimated based on triples with its positive predictions. Among those triples, 43% do not satisfy the typing constraint, but the baseline implicitly predicts them as satisfied. That supports the claim that LLMs and advanced prompting techniques become less effective in handling explicit constraints in CSKB reasoning.

### 5.2 Cost Estimation

In FIG. 10, the total number of words processed for each instance in each baseline is estimated, as well as the overhead cost of using additional prompt engineering techniques. The cost of exemplar optimization is ignored, as the process is done at most once per baseline and independent of the size of the test set. As such, here we treat Few-shot (KATE(-s)) the same as Few-shot (Random), and treat Active-CoT and Automate-CoT the same as Few-shot-CoT. Also, since the constraint design of ConstraintChecker only involves the head and tail events of test triples, which are irrelevant to seed prompt designs for the main-task component, ConstraintChecker only needs to be run once then apply it to all baselines and for all seed prompt designs. Overall, it shows the efficiency of ConstraintChecker over other types of prompt engineering. While using exemplars brings a larger improvement than ConstraintChecker as shown in FIG. 3, the cost of using exemplars is of a much larger degree.

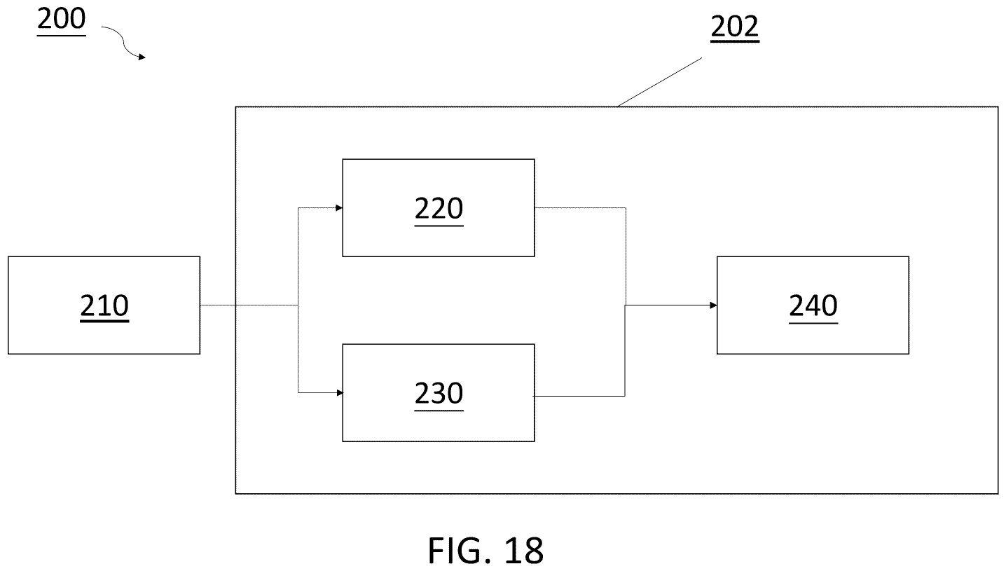

FIG. 18 depicts a block diagram for a system 200 for utilizing method of commonsense knowledge bases reasoning through constraint-based prompting according to some embodiments of the present invention. The system 200 includes a knowledge triple-query-processing module 210, a first prompt-processing module 220, a second prompt-processing module 230, and an aggregating module 240.

The triple-query-processing module 210 handles the inputting of queries that contain knowledge triples into the processor 202. The triple-query-processing module 210 takes queries with a head event, a relation, and a tail event in plain text format and converts them into a format that the processor's backbone large language model can interpret. The triple-query-processing module 210 ensures that the data is correctly formatted for processing, enabling accurate parsing and understanding of the queries. Then, through using the processor 202, it subjects the query to a main-task prompt engineering system 220 and a dual-module constraint-based prompt engineering system 230 simultaneously.

The main-task prompt engineering system 220 is responsible for obtaining generating a first prompt based on the query received from the main-task prompt engineering system and then subjecting this first prompt containing a prediction to the backbone large language model of the processor 202 to obtain a first prediction. The main-task prompt engineering system 220 ensures the seamless retrieval and processing of data, facilitating the accurate generation of predictions by effectively bridging the main-task prompt engineering system and the backbone large language model.

The dual-module constraint-based prompt engineering system 230 is responsible for obtaining generating a second prompt based on the query received from the main-task prompt engineering system, and then subjecting this second prompt to the backbone large language model of the processor 202 to obtain a second prediction. The dual-module constraint-based prompt engineering system 230 operates independently from the main-task prompt engineering system, and the second prompt received from the dual-module constraint-based prompt engineering system 230 contains a compilation of predictions to a multitude of questions further constructed with relational constraints.

The aggregating module 240 is responsible for aggregating predictions to produce a final result. The aggregating module 240 takes in the first prompt containing a prediction and the second prompt containing multiple additional predictions, then combines these results to obtain the final prediction through employing logical conjunction.

By this configuration, as evidenced in FIG. 10, the computational cost by using the dual-module constraint-based prompt engineering system 230 with ConstraintChecker prompt engineering system is significantly lower, thereby speeding up the computational speed of the processor in comparison to adopting other prompt-processing modules under the same computational cost.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

1. A method of commonsense knowledge bases reasoning through constraint-based prompting, comprising:
inputting, by using a knowledge triple-query-processing module, a query containing a knowledge triple comprising head event, relation and tail event in plain text format into a processor comprising a backbone large language model;
subjecting, by using the processor, the query to a main-task prompt engineering system and a dual-module constraint-based prompt engineering system simultaneously;
obtaining, by using a first prompt-processing module, a first prompt from the main-task prompt engineering system, and subjecting, by using the first prompt-processing module, the first prompt to the backbone large language model to obtain a first prediction;
obtaining, by using a second prompt-processing module, a second prompt from the dual-module constraint-based prompt engineering system, and subjecting, by using the second prompt-processing module, the second prompt to the backbone large language model to obtain a second prediction; and
aggregating, by using an aggregating module, the first prediction and the second prediction to obtain the final prediction.

2. The method of claim 1, wherein the dual-module constraint-based prompt engineering system comprises a first module and a second module, and wherein:
the first module generates relational constraints corresponding to the query;
the second module receives the relational constraints and generates the second prompt comprising questions on whether each of the relational constraints is satisfied on a zero-shot basis.

3. The method of claim 1, wherein relational constraints generated by the first module comprises:
typing constraint, wherein the tail event of the query is constrained to express the type of content that the relation expects; and
temporal constraint, wherein the temporal order of the head event and the tail event of the query is constrained to follow the order derived from the definition or human-readable template of the relation.

4. The method of claim 1, wherein the aggregating the first prediction and the second prediction comprises using logical conjunction.

5. The method of claim 1, wherein the F1 score is increased by an average margin of at least 0.75% in comparison with large language models without the dual-module constraint-based prompt engineering system.

6. A system for utilizing method of commonsense knowledge bases reasoning through constraint-based prompting, comprising:
a knowledge triple-query-processing module;
a processor comprising:
main-task prompt engineering system for generating a first prediction;
dual-module constraint-based prompt engineering system for generating a second prediction; and
aggregating module for aggregating the first prediction and the second prediction to obtain the final prediction;
wherein the dual-module constraint-based prompt engineering system comprises a first module generating relational constraints corresponding to the query; and a second module receiving the relational constraints and generating the second prompt comprising questions on whether each of the relational constraints is satisfied on a zero-shot basis.

7. The system of claim 6, wherein relational constraints generated by the first module comprises:
typing constraint, wherein the tail event of the query is constrained to express the type of content that the relation expects; and
temporal constraint, wherein the temporal order of the head event and the tail event of the query is constrained to follow the order derived from the definition or human-readable template of the relation.

8. The system of claim 6, wherein the aggregating the first prediction and the second prediction comprises using logical conjunction.

9. The system of claim 6, wherein the F1 score is increased by an average margin of at least 0.75% in comparison with large language models without the dual-module constraint-based prompt engineering system.
